(19) United States
(12) Patent Application Publication
(10) Pub. No.: US 2026/0310441 A1
(43) Pub. Date: Oct. 8, 2026

(54) MANAGEMENT SYSTEM

(71) Applicant: TOYOTA JIDOSHA KABUSHIKI KAISHA, Toyota-shi (JP)

(72) Inventor: Kazuho SAEKI, Kawasaki-shi (JP)

(73) Assignee: TOYOTA JIDOSHA KABUSHIKI KAISHA, Toyota-shi (JP)

(21) Appl. No.: 19/461,962

(22) Filed: Jan. 28, 2026

(30) Foreign Application Priority Data
Mar. 28, 2025 (JP) 2025-056871

(51) Int. Cl. G06F 8/65

(52) U.S. Cl. CPC G06F 8/65

(57) ABSTRACT

A management system according to the present disclosure includes an acquisition unit that acquires information on a dataset to be analyzed, a monitoring unit that monitors an execution status of processing of each of a plurality of processing steps in data analysis performed using the dataset, and an output unit that outputs a data analysis result and a monitoring result, in which in a case where the dataset is updated, the output unit outputs, out of the processing of each of the processing steps, information on processing that is determined by the monitoring unit to be re-executed.

### CROSS-REFERENCE TO RELATED APPLICATION

This application claims priority to Japanese Patent Application No. 2025-056871 filed on Mar. 28, 2025. The disclosure of the above-identified application, including the specification, drawings, and claims, is incorporated by reference herein in its entirety.

### BACKGROUND

### 1. Technical Field

The present disclosure relates to a management system.

### 2. Description of Related Art

In general, in data analysis, for example, a plurality of processing steps such as preprocessing, feature extraction (feature amount extraction), regression analysis, and optimization is performed on a dataset to be analyzed. For example, a technique related to data analysis is disclosed in Japanese Unexamined Patent Application Publication No. 2021-181940 (JP 2021-181940 A).

### SUMMARY

In data analysis including a plurality of processing steps, when a dataset to be analyzed is updated, there is a problem in that which processing of a processing step is to be re-executed is difficult to be determined. In particular, the problem becomes more pronounced as a scale of the data analysis increases.

The present disclosure has been made in view of the above background, and an object thereof is to provide a management system enabling efficient data analysis.

A management system according to the present disclosure is a management system including

an acquisition unit configured to acquire information on a dataset to be analyzed,

a monitoring unit configured to monitor an execution status of processing of each of a plurality of processing steps in data analysis performed using the dataset, and

an output unit configured to output a data analysis result and a monitoring result,

in which the output unit is configured to output, out of the processing of each of the processing steps, information on processing that is determined by the monitoring unit to be re-executed, when the dataset is updated.

The management system according to the present disclosure outputs information on processing of a processing step that is to be re-executed among the processing steps in the data analysis performed using the dataset, when data included in the dataset to be analyzed is updated. As a result, for example, a user can efficiently perform the data analysis.

According to the present disclosure, it is possible to provide the management system enabling the efficient data analysis.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration example of a management system according to the present disclosure;

FIG. 2 is a diagram showing an example of an output content of the management system according to the present disclosure;

FIG. 3 is a diagram showing an example of an output content of the management system according to the present disclosure;

FIG. 4 is a diagram showing an example of an output content of the management system according to the present disclosure;

FIG. 5 is a diagram showing another example of the output content of the management system according to the present disclosure;

FIG. 6 is a diagram showing another example of the output content of the management system according to the present disclosure; and

FIG. 7 is a diagram showing another example of the output content of the management system according to the present disclosure.

### DETAILED DESCRIPTION OF EMBODIMENTS

Hereinafter, specific embodiments of the disclosure will be described in detail with reference to the drawings. Note that the embodiments of the disclosure are not limited to the following embodiments. Further, in order to clarify the explanation, the following description and drawings are appropriately simplified.

### Configuration Example of Management System 100

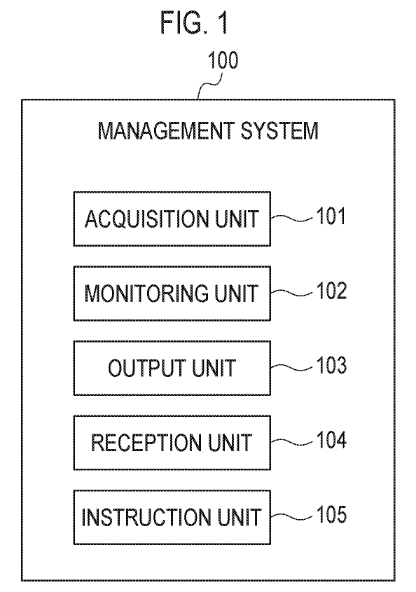

FIG. 1 is a block diagram showing a configuration example of a management system 100 according to the present disclosure. The management system 100 is a system that manages an execution status of processing of each of a plurality of processing steps in data analysis. The data analysis is performed by an analysis device (not shown) using a dataset to be analyzed. Here, the dataset to be analyzed is, for example, an X-ray diffraction (XRD) analysis result for a crystal structure of a material to be analyzed. In addition, the data analysis is, for example, analysis of an estimation model of a crystal structure of a material to be analyzed. The management system 100 collectively manages a workflow (a flow of processing of each of a plurality of processing steps) of each of one or a plurality of data analyses.

As shown in FIG. 1, the management system 100 includes an acquisition unit 101, a monitoring unit 102, an output unit 103, a reception unit 104, and an instruction unit 105. The management system 100 may include the analysis device (not shown), or may be provided separately from the analysis device.

The acquisition unit 101 acquires information on a dataset to be analyzed. For example, the acquisition unit 101 acquires an XRD analysis result (measurement data) for a crystal structure of a material to be analyzed.

The monitoring unit 102 monitors an execution status of processing of each of a plurality of processing steps in data analysis performed using a dataset. The plurality of processing steps in the data analysis is configured by, for example, a selection step of a dataset used for the data analysis, a preprocessing step of the selected dataset, and a step of extracting a feature amount from the dataset that has been preprocessed. In addition, the plurality of processing steps also includes a step of performing regression analysis using the extracted feature amount and sample data, and a step of optimizing a regression analysis result. However, the plurality of processing steps is not limited thereto, and may be configured by any plurality of processing steps.

The output unit 103 outputs a data analysis result and a monitoring result by the monitoring unit 102. The data analysis result is, for example, an estimation model of a crystal structure of a material to be analyzed. The monitoring result by the monitoring unit 102 is an execution status or the like of processing of each of the plurality of processing steps in the data analysis. The output content of the output unit 103 is displayed on, for example, a monitor (not shown).

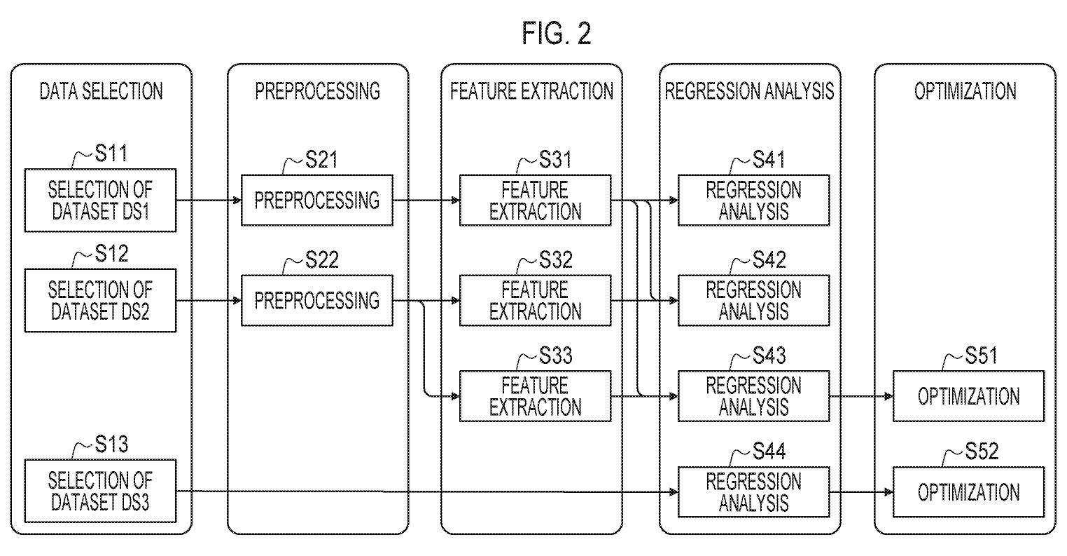

FIGS. 2 to 4 are diagrams showing an example of the output content of the output unit 103 (that is, the display content of the monitor). It should be noted that FIGS. 2 to 4 show an execution status of each of a plurality of data analyses that is a part of the monitoring result by the monitoring unit 102. In the examples of FIGS. 2 to 4, the processing of each processing step is represented by a rectangular icon in which a processing name is described, and the flow of processing is represented by an arrow.

As shown in FIG. 2, first, in the workflow of the data analysis using a dataset DS1, selection S11 of the dataset DS1, preprocessing S21, feature extraction S31, and any one of regression analyses S41 to S43 are performed. In a case where the regression analysis S43 is performed, then optimization S51 is performed. In the workflow of the data analysis using a dataset DS2, selection S12 of the dataset DS2, preprocessing S22, and any one of feature extractions S32, S33 are performed. In a case where the feature extraction S32 is performed, then the regression analysis S42 is performed. In a case where the feature extraction S33 is performed, then the regression analysis S43 and the optimization S51 are performed. In the workflow of the data analysis using a dataset DS3, selection S13 of the dataset DS3, the regression analysis S44, and the optimization S52 are performed.

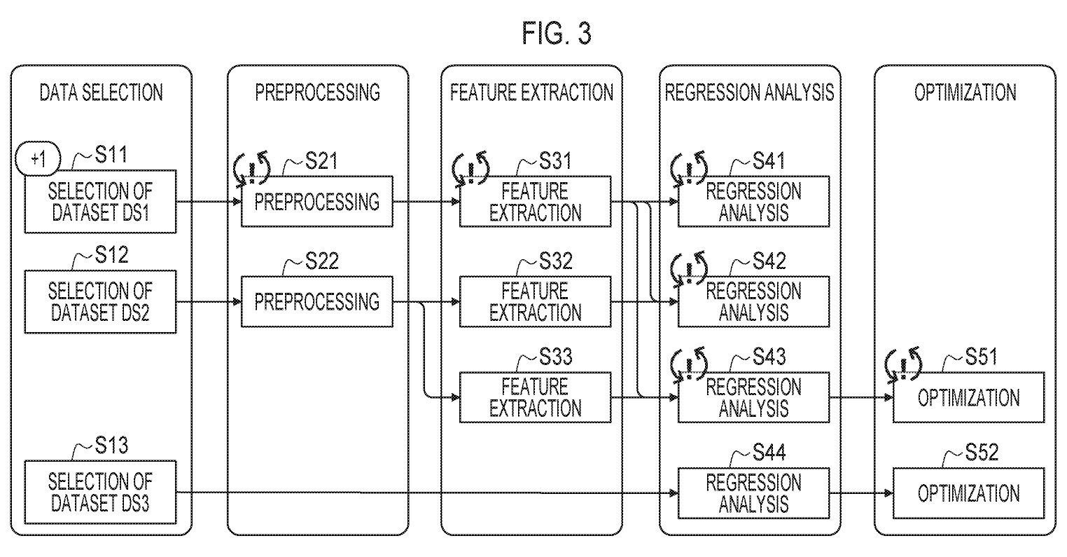

Here, for example, in a case where new measurement data is added to the dataset DS1, that is, in a case where the dataset DS1 is updated, the process is performed as shown in FIG. 3. In this case, a mark of "+1" is added to the icon representing the selection S11 of the dataset DS1. In addition, in a case where the dataset DS1 is updated, each processing of the data analysis using the dataset DS1 needs to be re-executed. Therefore, in association with the update of the dataset DS1, a mark including "!" is added to the icon representing the processing that needs to be re-executed. Specifically, a mark including "!" is added to the icon representing each processing after the dataset selection in the data analysis using the dataset DS1. As a result, the user who sees the monitor can recognize that the processing to which the mark including "!" is added needs to be re-executed, and thus the omission of the re-execution can be prevented. It should be noted that the extraction of the processing that needs to be re-executed is automatically performed by the monitoring unit 102. The mark of "+1" or the mark including "!" is output by the output unit 103.

It should be noted that the mark of "+1" or the mark including "!" is merely an example, and may be any mark that can be recognized by the user. For example, a mark in which an order of re-execution of each of the plurality of pieces of processing that needs to be re-executed is described may be used instead of the mark including "!". In addition, the corresponding icon may be emphasized instead of adding the mark to the corresponding icon. For example, the corresponding icon may blink or be displayed in a predetermined color.

The reception unit 104 receives operation information of an operation terminal operated by the user. For example, in a case where the operation terminal is a tablet terminal in which a touch panel is superimposed and disposed on the monitor, the reception unit 104 receives the operation information input by the user by touching the touch panel with a finger or a touch pen. Alternatively, in a case where the operation terminal is a personal computer (PC), the reception unit 104 receives operation information of a mouse or a keyboard operated by the user in accordance with the display content of the monitor.

Here, the reception unit 104 receives operation information for instructing the re-execution of the processing that needs to be re-executed due to the update of the dataset. For example, in a case where the icon of the processing with the mark including "!" displayed on the monitor is selected (tapped or clicked) by the operation of the user, the reception unit 104 receives the operation information for instructing the re-execution of the processing corresponding to the selected icon.

In a case where the reception unit 104 receives the operation information for instructing the re-execution of the processing that needs to be re-executed, the instruction unit 105 issues an instruction to re-execute the processing that needs to be re-executed. As a result, the analysis device (not shown) performs the re-execution of the designated processing. In a case where the re-execution of the designated processing is completed, the mark including "!" added to the icon of the processing of which the re-execution is completed is deleted. In addition, the mark of "+1" added to the icon representing the selection S11 of the dataset DS1 is also deleted.

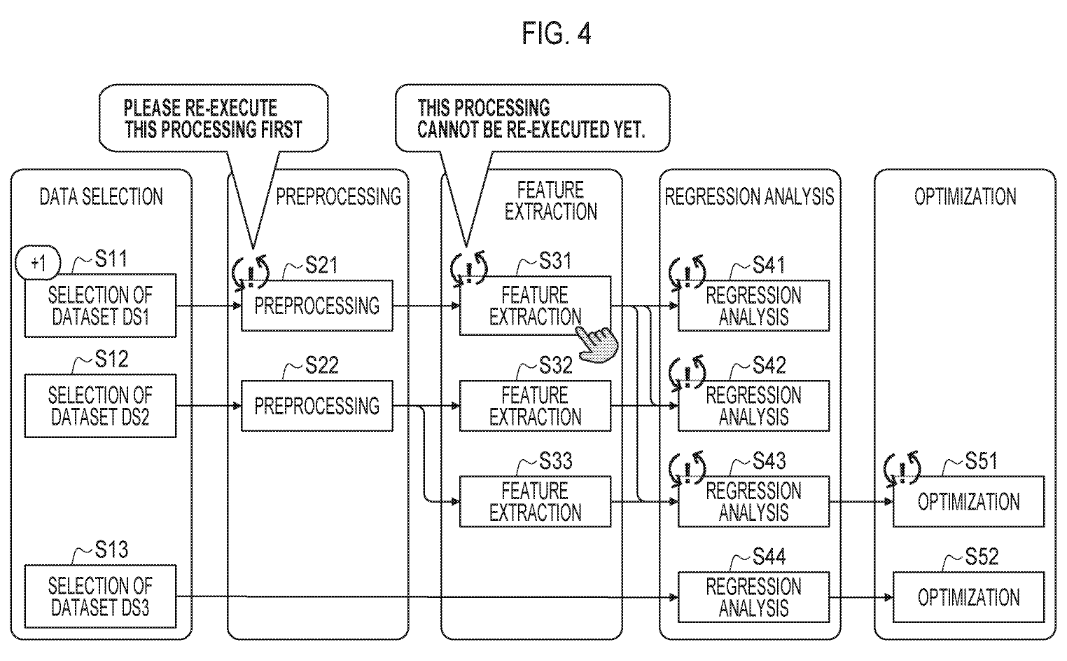

It should be noted that in a case where the re-execution of the plurality of pieces of processing is needed, out of the plurality of pieces of processing that needs to be re-executed, the re-execution needs to be performed in order from the processing of the preceding step. For example, as shown in FIG. 3, in a case where the re-execution of each of the preprocessing S21, the feature extraction S31, the regression analyses S41 to S43, and the optimization S51 is needed, the re-execution needs to be performed in order from the preprocessing S21. Therefore, for example, as shown in FIG. 4, a message such as "Please re-execute this processing first" may be additionally displayed on the icon representing the preprocessing S21. In addition, in a case where the icon representing the feature extraction S31 is selected (tapped or clicked) before the re-execution of the preprocessing S21, a message such as "This processing (feature extraction S31) cannot be re-executed yet" may be additionally displayed. In this case, the instruction of the feature extraction S31 by the instruction unit 105 is stopped. Alternatively, in a case where any of a plurality of icons representing each of the plurality of pieces of processing that needs to be re-executed is selected, all of the plurality of pieces of processing that needs to be re-executed may be executed in order.

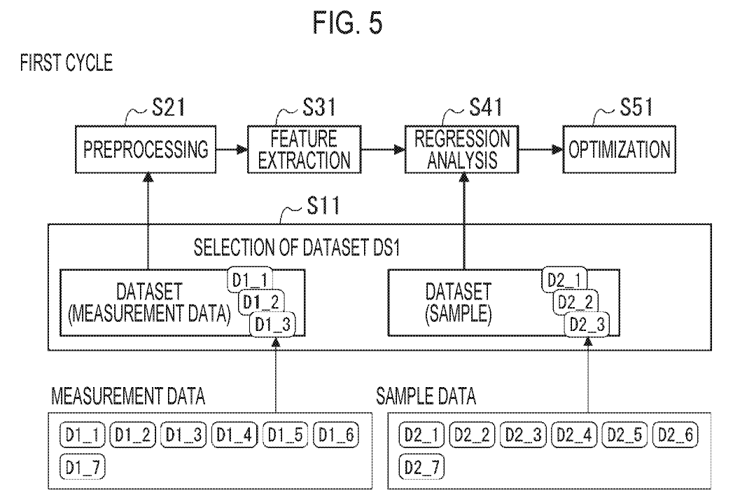

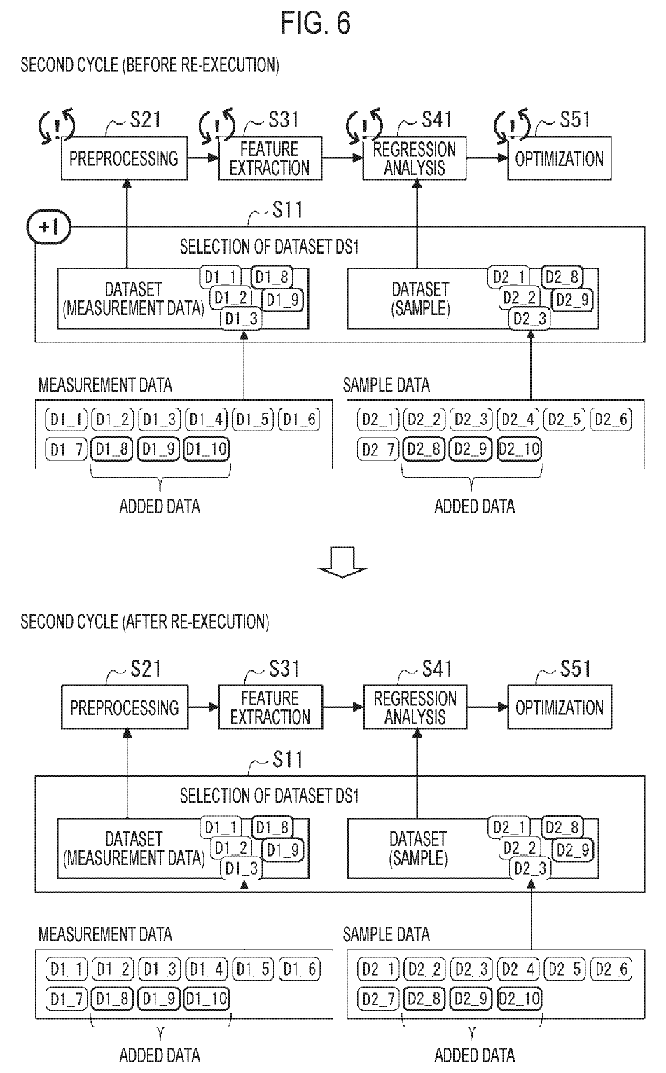

FIGS. 5 and 6 are diagrams showing another example of the output content of the output unit 103 (that is, the display content of the monitor). FIG. 5 shows an execution status of the first cycle data analysis using the dataset DS1. FIG. 6 shows an execution status of the second cycle data analysis using the dataset DS1.

As shown in FIG. 5, in the first cycle data analysis using the dataset DS1, measurement data D1_1 to D1_3 and sample data D2_1 to D2_3 are selected as the dataset DS1 (S11). After the selection S11 of the dataset DS1, the preprocessing S21, the feature extraction S31, the regression analysis S41 using the sample data D2_1 to D2_3, and the optimization S51 are performed on the measurement data D1_1 to D1_3.

Thereafter, as shown in FIG. 6, in the second cycle data analysis using the dataset DS1, in addition to the measurement data D1_1 to D1_3, measurement data D1_8, D1_9 is selected as the dataset DS1. In addition, in addition to the sample data D2_1 to D2_3, the sample data D2_8, D2_9 is selected (S11). That is, the dataset DS1 is updated. Therefore, a mark of "+1" is added to the icon representing the selection S11 of the dataset DS1. In addition, in association with the update of the dataset DS1, a mark including "!" is added to the icon representing the processing that needs to be re-executed. As a result, the user who sees the monitor can recognize that the processing to which the mark including "!" is added needs to be re-executed, and thus the omission of the re-execution can be prevented. It should be noted that the extraction of the processing that needs to be re-executed is automatically performed by the monitoring unit 102.

Thereafter, in a case where the re-execution of the processing that needs to be re-executed is completed, the mark including "!" added to the icon of the processing of which the re-execution is completed is deleted. In addition, the mark of "+1" added to the icon representing the selection S11 of the dataset DS1 is also deleted.

Information (snapshot) on the workflow of the data analysis of each cycle is recorded in a recording unit (not shown). A combination of the dataset used for the data analysis of each cycle and the analysis result of the dataset is also recorded in the recording unit (not shown). For example, the output unit 103 displays the information (snapshot) on the workflow of the data analysis of the designated cycle on the monitor based on the operation information received by the reception unit 104. In addition, the dataset used for the data analysis of the designated cycle and the analysis result of the dataset are displayed on the monitor. As a result, the user can check, for example, the change in the dataset DS1 used for the data analysis. Alternatively, the user can check the change in the analysis result in association with the change in the dataset DS1. In addition, by comparing the results of the data analysis of each cycle, it is possible to check whether the regression precision is improved, the degree of expansion of the interpolation space, and the like.

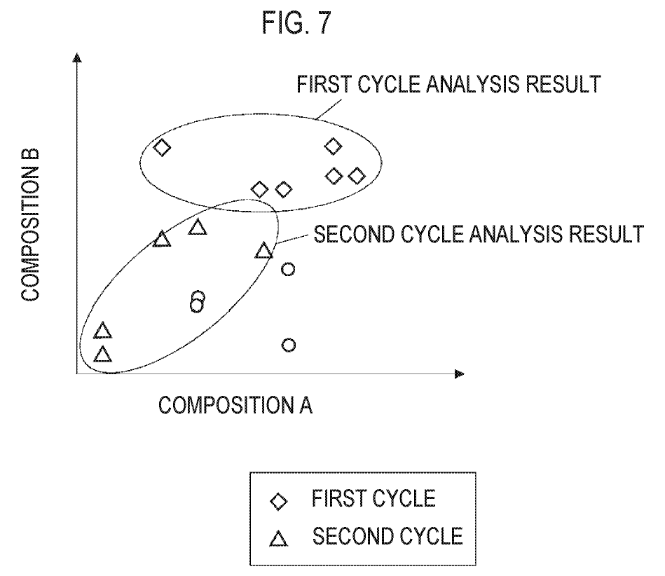

FIG. 7 is a diagram showing a result of the data analysis performed a plurality of times using the dataset DS1 as an example of the output content of the output unit 103 (that is, the display content of the monitor). For example, in a case where the display area of the result of the first cycle data analysis is selected (tapped or clicked) by the user, the output unit 103 may display the information (snapshot) on the workflow of the first cycle data analysis on the monitor based on the operation information received by the reception unit 104. In addition, the dataset used for the first cycle data analysis may be displayed on the monitor. Similarly, in a case where the display area of the result of the second cycle data analysis is selected (tapped or clicked) by the user, the output unit 103 may display the information (snapshot) on the workflow of the second cycle data analysis on the monitor based on the operation information received by the reception unit 104. In addition, the dataset used for the second cycle data analysis may be displayed on the monitor.

As described above, the management system 100 according to the present disclosure operates in a case where the data included in the dataset to be analyzed is updated. The processing step that needs to be re-executed among the plurality of processing steps of the data analysis performed using the dataset is specified. Then, the information on the processing is output. As a result, it is easy to understand which processing step needs to be re-executed, and thus, for example, the user can efficiently perform data analysis.

The present disclosure is not limited to the embodiment, and can be appropriately modified without departing from the spirit.

It should be noted that in the present disclosure, a part or all of the processing of the management system 100 can be implemented by causing a central processing unit (CPU) to execute a computer program.

The program includes an instruction group (or software code) for causing a computer to execute one or more functions described in the embodiment in a case where the program is read into the computer. The program may be stored on a non-transitory computer-readable medium or a tangible storage medium. As an example, but not limited thereto, the computer-readable medium or the tangible storage medium includes a random-access memory (RAM), a read-only memory (ROM), and a flash memory. In addition, a solid-state drive (SSD) or other memory technology, a CD-ROM, a digital versatile disc (DVD), a Blu-ray (registered trademark) disc, or other optical disc storage is also included. Further, a magnetic cassette, a magnetic tape, a magnetic disc storage, or other magnetic storage devices are included. The program may be transmitted on a transitory computer-readable medium or a communication medium. Examples of the transitory computer-readable medium or the communication medium include electrical, optical, acoustic, or other forms of propagating signals, but the transitory computer-readable medium or the communication medium is not limited to these examples.

Although the present disclosure has been described with reference to the embodiment, the present disclosure is not limited to the above-described embodiment. Various changes can be made to the configuration and details of the present disclosure within the scope of the present disclosure that can be understood by those skilled in the art. In addition, each embodiment can be appropriately combined with other embodiments.

What is claimed is:

1. A management system comprising:
an acquisition unit configured to acquire information on a dataset to be analyzed;
a monitoring unit configured to monitor an execution status of processing of each of a plurality of processing steps in data analysis performed using the dataset; and
an output unit configured to output a data analysis result and a monitoring result,
wherein the output unit is configured to output, out of the processing of each of the processing steps, information on processing that is determined by the monitoring unit to be re-executed, when the dataset is updated.

2. The management system according to claim 1, further comprising:
a reception unit configured to receive, out of information on the execution status of the processing of each of the processing steps in the data analysis, the information being output from the output unit, operation information instructing re-execution of the processing identified for re-execution due to an update of the dataset; and
an instruction unit configured to issue an instruction to re-execute the processing identified for re-execution when the reception unit receives the operation information instructing the re-execution of the processing identified for re-execution.

3. The management system according to claim 2, wherein:
the instruction unit is configured to stop, when the reception unit receives the operation information instructing the re-execution of the processing identified for re-execution, and processing of a preceding step relative to processing for which the instruction of the re-execution is received is to be re-executed, issuing the instruction of the re-execution; and
the output unit is configured to output information indicating that the processing of the preceding step relative to the processing for which the instruction of the re-execution is received is to be re-executed.

4. The management system according to claim 1, further comprising a recording unit configured to record the dataset used for the data analysis and the data analysis result using the dataset each time the dataset is updated, wherein the output unit is configured to be able to output a plurality of the datasets recorded in the recording unit and a plurality of the data analysis results corresponding to the datasets.

5. The management system according to claim 4, further comprising a reception unit configured to receive any one data analysis result selected from among the data analysis results output from the output unit, wherein the output unit is configured to output, from among the datasets recorded in the recording unit, information on a dataset used to derive the data analysis result received by the reception unit.
